(19) United States
(12) Patent Application Publication
(10) Pub. No.: US 2026/0056610 A1
(43) Pub. Date: Feb. 26, 2026

(54) INFORMATION PROCESSING APPARATUS, SYSTEM, INFORMATION PROCESSING METHOD, AND NON-TRANSITORY COMPUTER-READABLE MEDIUM

(71) Applicant: NEC Corporation, Minato-ku, Tokyo (JP)

(72) Inventors: Hiroki MAEDA, Tokyo (JP); Ayano SANDAIJI, Tokyo (JP); Yuka KAZAMA, Tokyo (JP); Yasuko ISHIKAWA, Tokyo (JP)

(73) Assignee: NEC Corporation, Minato-ku, Tokyo (JP)

(21) Appl. No.: 19/105,381

(22) PCT Filed: Sep. 7, 2023
(86) PCT No.: PCT/JP2023/032650

§ 371 Date: Feb. 21, 2025

(30) Foreign Application Priority Data
Sep. 21, 2022 (JP) 2022-150214

(51) Int. Cl. G06F 3/01; G09B 19/00

(52) U.S. Cl. CPC G06F 3/015; G09B 19/00

(57) ABSTRACT

An information processing apparatus (10) includes an acquisition unit (110), an analysis unit (130), and an output unit (150). The acquisition unit (110) acquires measurement information indicating at least one of a brain wave and a vital sign of a subject during learning, and attribute information of the subject. The analysis unit (130) generates state information relating to a state of the subject by use of the measurement information and the attribute information. The output unit (150) outputs the state information.

### TECHNICAL FIELD

The present invention relates to an information processing apparatus, a system, an information processing method, and a program.

### BACKGROUND ART

In a field of learning and education, an attempt to estimate a state of a learner and lead to better learning has been considered.

Patent Document 1 describes that a concentration degree of a subject is estimated by analyzing a change in vital data of the subject acquired by a vital sensor.

Patent Document 2 describes that a heartbeat of a learner is detected by use of a wearable sensor attached to an ear of the learner, and whether the learner concentrates attention is determined based on acquired heartbeat information.

Patent Document 3 describes that an understanding degree and a concentration degree of a learner are evaluated by analyzing a writing activity of the learner, based on writing data of the learner.

### RELATED DOCUMENTS

### Patent Documents

Patent Document 1: Japanese Patent Application Publication No. 2021-23492
Patent Document 2: Japanese Patent Application Publication No. 2022-77300
Patent Document 3: International Patent Publication No. WO2014/141414

### SUMMARY

### Technical Problem

However, the techniques in Patent Documents 1 to 3 described above do not perform analysis that takes into account an attribute of a learner, and therefore have a problem in that it is difficult to accurately estimate a state of each of learners with different characteristics.

In view of the problem described above, one example of an object of the present invention is to provide an information processing apparatus, a system, an information processing method, and a program that can perform more accurate state estimation by taking into account an attribute of a subject.

### Solution to Problem

According to one aspect of the present invention, there is provided an information processing apparatus including:
an acquisition unit that acquires measurement information indicating at least one of a brain wave and a vital sign of a subject during learning, and attribute information of the subject;
an analysis unit that generates state information relating to a state of the subject by use of the measurement information and the attribute information; and
an output unit that outputs the state information.

According to one aspect of the present invention, there is provided a system including:
the information processing apparatus;
a measurement apparatus that measures at least one of a brain wave and a vital sign of the subject; and
a terminal to which the output unit outputs the state information.

According to one aspect of the present invention, there is provided an information processing method including,
by one or more computers:
   acquiring measurement information indicating at least one of a brain wave and a vital sign of a subject during learning, and attribute information of the subject;
   generating state information relating to a state of the subject by use of the measurement information and the attribute information; and
   outputting the state information.

According to one aspect of the present invention, there is provided a program causing a computer to function as:
an acquisition unit that acquires measurement information indicating at least one of a brain wave and a vital sign of a subject during learning, and attribute information of the subject;
an analysis unit that generates state information relating to a state of the subject by use of the measurement information and the attribute information; and
an output unit that outputs the state information.

### Advantageous Effects of Invention

According to one aspect of the present invention, an information processing apparatus, a system, an information processing method, and a program that can perform more accurate state estimation by taking into account an attribute of a subject can be provided.

### BRIEF DESCRIPTION OF THE DRAWINGS

FIG. 1 It is a diagram illustrating an outline of an information processing apparatus according to a first example embodiment.

FIG. 2 It is a diagram illustrating an outline of a system according to the first example embodiment.

FIG. 3 It is a block diagram illustrating a functional configuration of the system according to the first example embodiment.

FIG. 4 It is a diagram illustrating a configuration of subject information.

FIG. 5 It is a diagram illustrating display of state information by a terminal.

FIG. 6 It is a diagram illustrating a computer for achieving an information processing apparatus.

FIG. 7 It is a diagram illustrating an outline of an information processing method according to the first example embodiment.

FIG. 8 It is a diagram illustrating a functional configuration of a system according to a second example embodiment.

FIG. 9 It is a diagram illustrating an image displayed on a terminal according to the second example embodiment.

FIG. 10 It is a diagram illustrating another example of an image displayed on the terminal according to the second example embodiment.

FIG. 11 It is a flowchart illustrating a flow of processing executed by an analysis unit according to a third example.

FIG. 12 It is a flowchart illustrating another example of a flow of processing executed by the analysis unit according to the third example.

### EXAMPLE EMBODIMENT

Hereinafter, example embodiments according to the present invention are described by use of the drawings. Note that, in all the drawings, a similar component is assigned with a similar reference sign, and description thereof is omitted as appropriate.

### First Example Embodiment

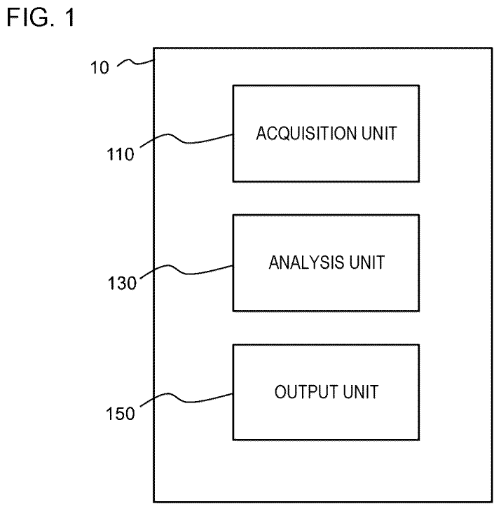

FIG. 1 is a diagram illustrating an outline of an information processing apparatus 10 according to the first example embodiment. The information processing apparatus 10 includes an acquisition unit 110, an analysis unit 130, and an output unit 150. The acquisition unit 110 acquires measurement information indicating at least one of a brain wave and a vital sign of a subject during learning, and attribute information of the subject. The analysis unit 130 generates state information relating to a state of the subject by use of the measurement information and the attribute information. The output unit 150 outputs the state information.

The information processing apparatus 10 can perform more accurate state estimation by taking into account an attribute of a subject.

A detailed example of the information processing apparatus 10 is described below:

For example, in an educational field such as a school, a teacher instructs a plurality of students and pupils. Students and pupils receiving instruction include children with various characteristics. Some children need special support. It is not easy for the teacher to perform suitable instruction for each of the children in such a state. The teacher may not sufficiently have knowledge regarding instruction of a child needing special support. In a case where a teacher can easily recognize a state of each child, and perform instruction suitable for each child, there is a benefit to both the teacher and children receiving the instruction. In other words, for the teacher, a trouble resulting from poor performance of instruction is reduced. For children, such a case that an instruction effect is not raised due to not being able to receive suitable instruction can be avoided.

In the present example embodiment, a subject is a learner, and is, for example, at least one of a student (junior high or high school student), a pupil (elementary school student), and a student at a university, a graduate school, a vocational school, or the like. An age of a subject is not particularly limited, and may be an adult or a child (e.g., equal to or less than 18 years old). The information processing apparatus 10 is particularly suitable for designating, as a subject, a student or a pupil in an elementary school, a junior high school, a high school, a special support school, or the like where education is performed on various children.

Learning that a subject performs includes learning of a curriculum or a course, learning relating to a hobby, a qualification, or a skill, and the like. A subject can perform learning by receiving instruction of an instructor such as a teacher and a lecturer. A location where a subject performs learning is not particularly limited. For example, a subject performs learning in a classroom at a school or the like, at home, or in another learning room or the like. Examples of “during learning” include, for example, during a lesson, during a lecture, when a subject receives instruction, and when a subject is self-learning.

An instructor may instruct a subject face to face in a classroom or the like, or may instruct a subject remotely online. Otherwise, an instructor may instruct a subject in a virtual space such as a metaverse. An instructor may instruct a subject one-on-one, or may simultaneously instruct a plurality of subjects. In a case where an instructor simultaneously instructs a plurality of subjects, it becomes particularly difficult to recognize a state of each subject in detail, and, therefore, it is particularly preferable to acquire state information by the 15 information processing apparatus 10 according to the present example embodiment.

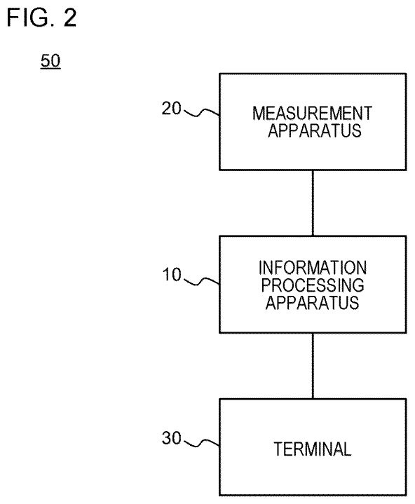

FIG. 2 is a diagram illustrating an example of an outline of a system 50 according to the present example embodiment. The system 50 according to the present example embodiment includes an information processing apparatus 10, a measurement apparatus 20, and a terminal 30. The measurement apparatus 20 measures at least one of a brain wave and a vital sign of a subject. The output unit 150 of the information processing apparatus 10 outputs state information to the terminal 30.

The system 50 can be said to be an instruction support system or a learning support system. The information processing apparatus 10 can perform wired communication or wireless communication with the measurement apparatus 20. The information processing apparatus 10 can perform wired communication or wireless communication with the terminal 30. The information processing apparatus 10 may be connected to at least one of the measurement apparatus 20 and the terminal 30 via a communication network.

As described above, the measurement apparatus 20 measures at least one of a brain wave and a vital sign of a subject. In the present example embodiment, a vital sign is, for example, one or more of a pulse rate, a heartbeat, respiration, blood pressure, a surface temperature, and a body temperature. The measurement apparatus 20 is a measurement apparatus that is worn by a subject or touched during learning, and thereby measures at least one of a brain wave and a vital sign. The measurement apparatus 20 can be a contact-type measurement apparatus.

Examples of the measurement apparatus 20 include an earphone, a pencil-shaped device, a head-mount-type device, a necklace-shaped device, a finger-ring-shaped device, a wristwatch, and a wristband-shaped device. The system 50 can include a plurality of the measurement apparatuses 20. Moreover, a plurality of the measurement apparatuses 20 may be provided for one subject. The system 50 may include a plurality of types of measurement apparatuses 20.

A subject during learning wears or uses one or more measurement apparatuses 20. The measurement apparatus 20 measures at least one of a brain wave and a vital sign of a subject wearing or using the measurement apparatus 20. The measurement apparatus 20 is associated with a subject that the measurement apparatus 20 is to designate as a measurement target. Specifically, each subject is given unique identification information (hereinafter, also referred to as “individual ID”). In a case where a plurality of subjects exist, each subject is identifiable by an individual ID. Then, the measurement apparatus 20 is previously associated with an individual ID of a subject being a measurement target of the measurement apparatus 20.

The measurement apparatus 20 measures at least one of a brain wave and a vital sign of a subject wearing or using the measurement apparatus 20, and generates and outputs measurement information indicating at least one of the brain wave and the vital sign. The measurement information may be a measurement result at a certain time point, may be a statistical value (an average value, a maximum value, a minimum value, or the like) of a measurement result at a predetermined time, or may be time-series measurement data for a predetermined time. In this instance, the measurement apparatus 20 outputs an individual ID associated with the measurement apparatus 20 in association with the measurement information. In this way, which subject each piece of measurement information pertains to can be identified. The acquisition unit 110 of the information processing apparatus 10 acquires the measurement information and the individual ID output from the measurement apparatus 20.

Note that, instead of outputting an individual ID, the measurement apparatus 20 may output identification information given to the measurement apparatus 20 (hereinafter, also referred to as “measurement apparatus ID”), in association with the measurement information. The measurement apparatus ID is identification information unique to each of the measurement apparatuses 20, and, in a case where the system 50 includes a plurality of the measurement apparatuses 20, each of the measurement apparatuses 20 is identifiable by the measurement apparatus ID. The acquisition unit 110 that has acquired the measurement apparatus ID specifies an individual ID being associated with the measurement apparatus ID, by use of ID reference information that associates the measurement apparatus ID with the individual ID. Then, the acquisition unit 110 associates the specified individual ID with the measurement information. The ID reference information is previously held in a storage apparatus (e.g., a subject storage unit 120 described later) accessible from the acquisition unit 110, and can be read and used by the acquisition unit 110. Note that, this storage apparatus may be provided inside the information processing apparatus 10, or may be provided outside the information processing apparatus 10.

For example, the measurement apparatus 20 repeatedly outputs measurement information to the information processing apparatus 10 at a predetermined cycle. Otherwise, measurement may be performed by the measurement apparatus 20 and measurement information may be output due to a fact that a predetermined operation (hereinafter, also referred to as a “request operation”) is performed on the terminal 30 for requesting output of state information. Examples of a request operation include an operation for displaying state information and an operation of selecting a desired subject on the terminal 30.

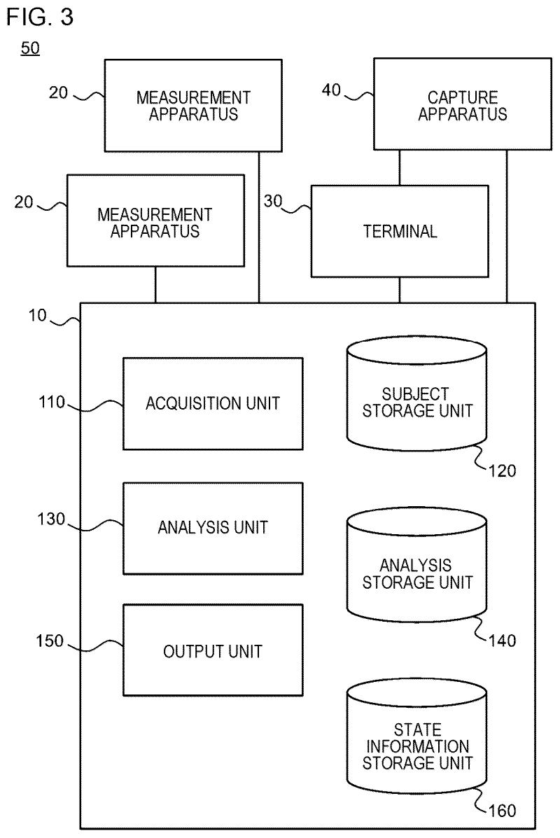

FIG. 3 is a block diagram illustrating a functional configuration of the system 50 according to the present example embodiment. The information processing apparatus 10 according to the present example embodiment further includes a subject storage unit 120, an analysis storage unit 140, and a state information storage unit 160. However, at least one of the subject storage unit 120, the analysis storage unit 140, and the state information storage unit 160 may be provided outside the information processing apparatus 10. The subject storage unit 120 is accessible from the acquisition unit 110, and previously holds subject information. The subject information is information in which attribute information is associated with each of the individual IDs of a plurality of subjects. The analysis storage unit 140 is accessible from the analysis unit 130, and previously holds analysis information necessary for generation of state information. The state information storage unit 160 stores the generated state information. In the example of FIG. 3, the system 50 includes a plurality of the measurement apparatuses 20 and a capture apparatus 40. According to the capture apparatus 40, a subject can be captured. Examples of the capture apparatus 40 include a fixed camera, a wearable camera, and a VR camera. In a case where the capture apparatus 40 is a wearable camera, the wearable camera is worn by, for example, an instructor.

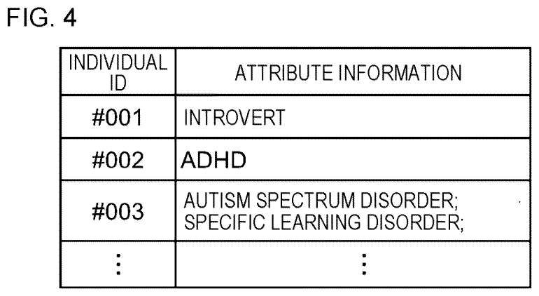

FIG. 4 is a diagram illustrating a configuration of subject information. Attribute information indicates one or more attributes. Each individual ID is associated with one or more attributes. A collection of one or more attributes associated with an individual ID of a subject is called attribute information of the subject. The attribute information can include, as an attribute, one or more of an age, a gender, an attribute relating to a personality, an attribute relating to a factor needing support, an attribute relating to a hobby, and an attribute relating to preference.

Among the attributes, it is preferable that attribute information includes an attribute relating to a factor needing support. Examples of an attribute relating to a factor needing support include information relating to difficulty of a subject, information relating to a language of a subject, information relating to attendance status, and information indicating that there is no support factor. Among the attributes, it is preferable that attribute information includes, as an attribute, at least one of information relating to difficulty of a subject and information relating to a language of a subject.

Examples of information relating to difficulty of a subject include visual difficulty, hearing difficulty, intellectual disability, physical disability, invalidism, physical fragility, speech difficulty, autism, emotional difficulty, learning difficulty, and attention deficit hyperactivity disorder. By including information relating to difficulty of a subject in attribute information, a change in a state of the subject having difficultly that is difficult to determine with the same criterion as a pupil or a student having no difficulty can be taken into account, and an instructor can make use of the information in instruction. Examples of information relating to a language of a subject include information indicating that a language used for instruction is not a first language of the subject, and an understanding degree of the subject regarding a language used for instruction. By including information relating to a language of a subject in attribute information, a state of the subject who is an international student or a foreigner can be taken into account, and an instructor can make use of the information in instruction.

Attribute information for each subject can be determined based on a result of a preliminary questionnaire, test, survey, or the like.

Returning to FIG. 3, in a case where the acquisition unit 110 acquires measurement information as described above, the acquisition unit 110 acquires attribute information regarding an individual ID associated with the measurement information. Specifically, the acquisition unit 110 acquires attribute information associated with an individual ID of a subject in subject information held in the subject storage unit 120. In this way; the acquisition unit 110 can acquire measurement information and attribute information of each subject. The acquisition unit 110 may collectively acquire or sequentially acquire measurement information and attribute information of a plurality of subjects.

In a case where the acquisition unit 110 acquires measurement information and attribute information, the analysis unit 130 generates state information relating to a state of the subject by use of the measurement information and the attribute information. The state information can be information relating to at least one of a state of the subject at a measurement time point where the measurement information is acquired and a state of the subject after the measurement time point. The state information indicates, for example, at least one of an emotion, a concentration degree, and an understanding degree of the subject. In the present example embodiment, an example in which state information relates to a state of the subject at the measurement time point where measurement information is acquired is described below.

The analysis unit 130 generates state information by reading analysis information held in the analysis storage unit 140 and using the analysis information for analysis of measurement information. The analysis storage unit 140 holds a plurality of pieces of analysis information each associated with one attribute or a combination of two or more attributes. In other words, analysis information being associated with a content of attribute information is previously prepared and held in the analysis storage unit 140. The analysis unit 130 selects, based on attribute information of the subject, the analysis information to be used from a plurality of pieces of analysis information, and uses the selected analysis information for generation of state information. Specifically, the analysis unit 130 selects analysis information in such a way that one or more attributes indicated in attribute information of the subject match one or more attributes associated with analysis information used for generation of state information. In this way; analysis using different analysis information is performed depending on attribute information, and analysis suitable for an attribute of the subject can be performed.

However, the analysis storage unit 140 does not necessarily need to hold analysis information regarding all combinations of attributes. Analysis information may be held regarding at least an attribute and a combination of attributes having a possibility of being used. In a case where the analysis storage unit 140 does not hold analysis information of a combination of attributes completely matching the attribute information, the analysis unit 130 may use analysis information of a combination of attributes having the highest similarity degree to the attribute information. A method in which the analysis unit 130 generates state information relating to a state of the subject by use of measurement information and attribute information is described in detail later.

The output unit 150 outputs, to the terminal 30, state information generated by the analysis unit 130. The terminal 30 is, for example, a terminal used by an instructor. Examples of the terminal 30 include a computer, a smartphone, a tablet, a smart glass, and an earphone.

For example, the output unit 150 can output state information in real time to a terminal used by an instructor who instructs a subject at a measurement time point where measurement information is acquired. Specifically, as soon as state information is generated by the analysis unit 130, the output unit 150 outputs the state information. A time lag from measurement of measurement information to display is, for example, within one minute. Otherwise, in a case where a measurement time point is during a lesson, the output unit 150 outputs measurement information during the lesson at the latest. By outputting state information in real time, an instructor can recognize a state of the subject, and perform an appropriate action.

Moreover, the output unit 150 may further output notification information to the terminal 30 in a case where state information satisfies a previously determined condition. For example, in a case where the state information indicates a calmness degree, the analysis unit 130 determines whether the calmness degree is equal to or less than a previously determined threshold value. In a case where the degree of calmness is equal to or less than a previously determined threshold value, the analysis unit 130 generates notification information. Moreover, the output unit 150 further outputs notification information to the terminal 30. On the other hand, in a case where a calmness degree exceeds a previously determined threshold value, the analysis unit 130 does not generate notification information. Moreover, the output unit 150 does not output notification information to the terminal 30. In this way, the instructor can receive an alert in a case where there is a subject with a heightened emotion, and perform an action necessary for the subject. Note that, a threshold value used herein may be included in analysis information. In that case, determination with a different threshold value is performed depending on attribute information.

In a case where the terminal 30 acquires state information from the output unit 150, the terminal 30 outputs the state information in such a way as to be recognizable by a user of the terminal 30. For example, the terminal 30 outputs state information by at least one of sound and display. The terminal 30 may output state information by use of an augmented reality (AR) technique. A user of the terminal 30 is not particularly limited, but is, for example, at least one of an instructor who instructs a subject, a supervisor who supervises learning status of the subject or instruction status of the instructor, a doctor, and a researcher. The terminal 30 may be used in the same space, for example, the same classroom as the subject, or may be used in a different location from the subject, for example, a separate room.

For example, in a case where the terminal 30 is a smart glass, a user of the terminal 30 sees a subject via a translucent display member provided on the smart glass. A smart glass displays, by use of the AR technique, state information in such a way that the state information is superimposed on the subject.

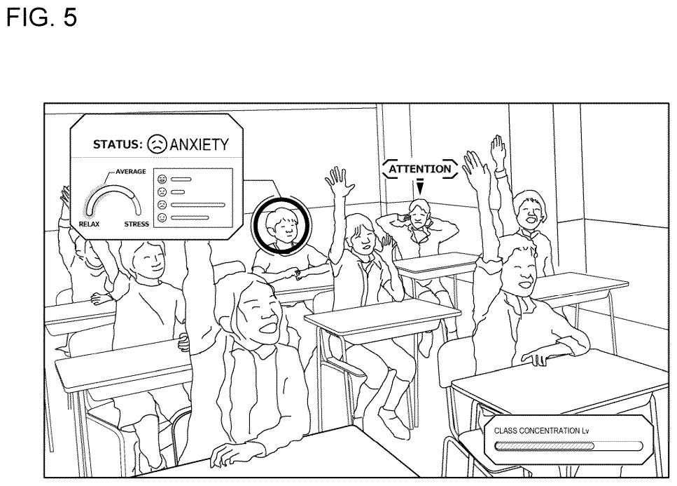

FIG. 5 is a diagram illustrating the display of state information by the terminal 30. In an example of FIG. 5, a teacher wears a smart glass being the terminal 30, and gives a lesson. The terminal 30 includes a sensor that detects movement of an eye of a teacher. In a case where the teacher turns a gaze to a specific child for equal to or more than a predetermined time among a plurality of pupils (subjects) taking the lesson, a state of the pupil is displayed in real time. For example, in the present figure, a face of the pupil is surrounded by a circle, and a diagram illustrating main status (“STATUS”), a balance between a relaxation degree and a stress degree, and a degree of each sentiment is displayed. Turning a gaze to a specific pupil for equal to or more than a predetermined time can be equivalent to the request operation described above.

Moreover, a symbol (“ATTENTION”) or the like indicating an alert is displayed for a pupil in a confused state or the like needing attention. Further, an average of a concentration degree of the entire class (“CLASS CONCENTRATION Ly”) is displayed.

In a case where the terminal 30 outputs state information by use of the AR technique, the acquisition unit 110 of the information processing apparatus 10 acquires an image including a subject from the capture apparatus 40, and the analysis unit 130 specifies a position of the subject by use of the acquired image. The capture apparatus 40 is, for example, a camera such as a virtual reality (VR) camera. The capture apparatus 40 may capture a subject from a plurality of directions. Moreover, a capture region of the capture apparatus 40 may be fixed or may be variable. The capture apparatus 40 may be worn by the user of the terminal 30, or may be included in the terminal 30.

Moreover, in subject information of the subject storage unit 120, each individual ID is further associated with a feature value for face recognition processing. In a case where the analysis unit 130 of the information processing apparatus 10 acquires a feature value of a subject from the subject storage unit 120, the analysis unit 130 performs face recognition processing on an image generated by the capture apparatus 40 by use of the feature value. In this way, a position of the subject in the image is specified. Moreover, a position of the subject in a real space can be specified by use of a position of the subject in the image, a position of the capture apparatus 40, and a relationship between the capture apparatus 40 and a capture region. In a case where a position of the subject is specified, the output unit 150 outputs the position of the subject to the terminal 30 in association with the state information. The terminal 30 can determine, based on the position of the subject, the position of the terminal 30, and a direction of the terminal 30, a position where state information is to be displayed on the terminal 30, and the like. Note that, the specification of a position of the subject described above may be performed by the terminal 30.

As another example, in a case where the terminal 30 is a computer, a smartphone, or a tablet, an image including a subject is displayed on a display of the terminal 30 along with state information. An image including the subject is captured by, for example, the capture apparatus 40. As described above, the capture apparatus 40 may be included in the terminal 30. Then, by performing face recognition processing on the image including the subject as described above, a position of each subject in the image may be recognized, and a display position of state information of each subject may be determined based on the position. The face recognition processing and determination of a display position may be performed by the information processing apparatus 10, or may be performed by the terminal 30.

A method in which the analysis unit 130 generates state information relating to a state of a subject by use of measurement information and attribute information is described in detail below:

The analysis unit 130 may perform generation of state information on a predetermined rule basis or by use of a model generated by machine learning. Each example is described below:

### First Example

In a first example, the analysis unit 130 performs generation of state information on a predetermined rule basis. In this case, analysis information read from the analysis storage unit 140 and used by the analysis unit 130 is information indicating a rule for generating state information, based on measurement information. The analysis information includes, for example, one or more of a mathematical formula, a condition, and a threshold value. Analysis information being associated with each piece of attribute information can be previously prepared by collecting and analyzing data indicating a relationship between a brain wave or a vital sign of a learner with the attribute and a state of the learner at a timing at which the brain wave or the vital sign are measured.

### <<Brain Wave>>

In a case where measurement information includes a brain wave, the analysis unit 130 can estimate a state of a subject by use of an existing method such as the Russell ring model. For example, the analysis unit 130 performs processing of removing noise from a brain wave waveform, and then extracts each component of an alpha wave, a gamma wave, a beta wave, a theta wave, and a delta wave. The analysis unit 130 computes each of an activity degree and a comfort degree by applying the components to a predetermined mathematical formula. Then, the analysis unit 130 can estimate an emotion of the subject, based on a position in a case where the computed activity degree and comfort degree are arranged on a biaxial plane with a vertical axis as the activity degree and a horizontal axis as the comfort degree. Herein, the analysis information includes, for example, a mathematical formula for computing each of an activity degree and a comfort degree from each component of a brain wave.

As another example, the analysis unit 130 computes a ratio of a beta wave to an alpha wave (B/a), and a variation in a component equal to or less than a predetermined frequency (LF fluctuation) in a waveform of a brain wave. Then, the analysis unit 130 can estimate an emotion, based on a position in a case where the computed B/a and LF fluctuation are arranged on a biaxial plane with a vertical axis as the B/a and a horizontal axis as the LF fluctuation. Herein, a way of taking a region in the biaxial plane to be allocated to each emotion can be the analysis information.

### <<Vital Sign>>

The analysis unit 130 can estimate a state of a subject by use of a value of one or more vital signs such as a pulse rate, a heartbeat, respiration, blood pressure, a surface temperature, and a body temperature. For example, it can also be said that, as a pulse rate is lower, the subject is calmer. Moreover, it can be said that, in a case where an understanding degree decreases, a pulse rate, a body temperature, blood pressure, and the like increase due to impatience and agitation. For example, the analysis unit 130 substitutes a value of one or more vital signs into a mathematical formula prepared regarding each state, and thereby acquires a score indicating a probability that the subject is in the state. Specifically, by substituting values of a pulse rate, a body temperature, and blood pressure into a mathematical formula for deriving “highness of an understanding degree”, a score indicating highness of an understanding degree can be acquired. Otherwise, it can be said that, as variation of a pulse rate is smaller, the subject concentrates more. Therefore, the analysis unit 130 can substitute a variation rate of a pulse rate or a heart rate into a mathematical formula for deriving “highness of a concentration degree”, and thereby acquire a score indicating highness of a concentration degree. Note that, in this case, it is assumed that measurement information includes time-series measurement data of the pulse rate or the heartbeat. Analysis information can include such a mathematical formula. For example, the analysis information may include a mathematical formula for each emotion such as pleasure, anger, anxiety, calmness, and the like.

Moreover, the analysis unit 130 may generate state information by combining a plurality of methods as described above. For example, the analysis unit 130 acquires a state score indicating a probability or a degree of a certain state (“high in an understanding degree”, “pleased”, “angry”, “anxious”, “calm”, or the like) in each of a plurality of methods. Then, the analysis unit 130 computes an average, a sum, or a weighted sum of a plurality of acquired state scores, and thereby acquires an overall state score relating to the state. As an overall state score is higher, a possibility that the subject is in the state is indicated to be higher. Note that, each weight of the weighted sum may be further included in analysis information. The analysis unit 130 may similarly acquire an overall state score regarding each of a plurality of states.

State information generated by the analysis unit 130 may be information indicating a predetermined state that has been determined, or may be a score (a state score or an overall state score) indicating a probability regarding each of a plurality of states. Otherwise, in a case where a score (a state score or an overall state score) computed regarding a certain state is equal to or more than a predetermined criterion value that has been previously determined, the analysis unit 130 may estimate that the subject is in the state, and include information indicating the state in the state information. This criterion value may be further included in analysis information.

### Second Example

In a second example, the analysis unit 130 generates state information by use of a model generated by machine learning. In this case, analysis information is a model. In other words, the analysis storage unit 140 holds a plurality of models each associated with one attribute or a combination of two or more attributes. Then, the analysis unit 130 selects, based on attribute information of the subject, a model to be used from the plurality of models, and uses the selected model for generation of state information.

A model being associated with each piece of attribute information can be previously prepared by performing machine learning with, as training data, data indicating a relationship between a brain wave or a vital sign of a learner having the attribute, and a state of the learner at a timing at which the brain wave or the vital sign are measured.

Input of a model according to the present example is measurement information, and the output of a model is a likelihood of each of one or more states. As a likelihood is higher, a possibility that the subject is in the state is indicated to be higher. The analysis unit 130 acquires a likelihood of each of one or more states by inputting measurement information to a model read from the analysis storage unit 140. State information may be a likelihood regarding each of one or more states. Otherwise, in a case where a likelihood computed regarding a certain state is equal to or more than a predetermined criterion value that has been previously determined, the analysis unit 130 may determine that the subject is in the state, and include information indicating the state in state information. The criterion value may be further included in analysis information.

Moreover, the analysis unit 130 may generate state information further by use of an image of the subject during learning. In this case, input of a model further includes an image of the subject during learning. Such a model being associated with each piece of attribute information can be previously prepared by performing machine learning further with, as training data, an image of a learner during learning having the attribute.

The acquisition unit 110 acquires, from the capture apparatus 40, an image of the subject during learning. The analysis unit 130 acquires a likelihood of each state by inputting the image acquired by the acquisition unit 110 to the model together with the measurement information.

Note that, a method by which the analysis unit 130 generates state information is not limited to the example described above, and various methods can be adopted.

The analysis unit 130 associates an individual ID with the state information in such a way that which subject the generated state information pertains to can be identified. Alternatively, the analysis unit 130 may associate information indicating a position of a subject with state information. Information indicating a position can be generated based on an image acquired by the capture apparatus 40, as described above. The output unit 150 further outputs an individual ID associated with the state information or information indicating a position. The terminal 30 acquires the individual ID associated with the state information or the information indicating the position. The terminal 30 can determine at least one of a display position and a display format of each piece of state information, based on the individual ID or the information indicating the position.

In a situation where a plurality of subjects learn simultaneously, the analysis unit 130 generates state information of each subject. Then, the analysis unit 130 may further compute an average of state information of the plurality of subjects. In other words, an average value of a score or a likelihood included in the state information is computed for each state. Then, the output unit 150 can further output the computed average value. For example, by confirming such an average value during a lesson, an instructor can recognize status (atmosphere or the like) of an entire classroom.

A hardware configuration of the information processing apparatus 10 is described below: Each functional configuration unit (the acquisition unit 110, the analysis unit 130, and the output unit 150) of the information processing apparatus 10 may be achieved by hardware (example: a hardwired electronic circuit or the like) that achieves each functional configuration unit, or may be achieved by a combination of hardware and software (example: a combination of an electronic circuit and a program that controls the electronic circuit, or the like). Hereinafter, a case where each functional configuration unit of the information processing apparatus 10 is achieved by a combination of hardware and software is further described.

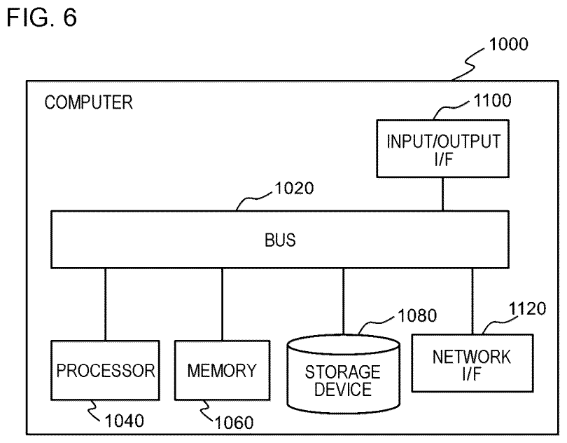

FIG. 6 is a diagram illustrating a computer 1000 for achieving the information processing apparatus 10. The computer 1000 is any computer. For example, the computer 1000 is a system on chip (SoC), a personal computer (PC), a server machine, a tablet terminal, a smartphone, or the like. The computer 1000 may be a dedicated computer designed in order to achieve the information processing apparatus 10, or may be a general-purpose computer. Moreover, the information processing apparatus 10 may be achieved by one computer 1000, or may be achieved by a combination of a plurality of the computers 1000.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to mutually transmit and receive data. However, a method of connecting the processor 1040 and the like to each other is not limited to bus connection. The processor 1040 is a variety of processors such as a central processing unit (CPU), a graphics processing unit (GPU), or a field-programmable gate array (FPGA). The memory 1060 is a main storage apparatus achieved by use of a random access memory (RAM) and the like. The storage device 1080 is an auxiliary storage apparatus achieved by use of a hard disk, a solid state drive (SSD), a memory card, a read only memory (ROM), and the like.

The input/output interface 1100 is an interface for connecting the computer 1000 and an input/output device. For example, an input apparatus such as a keyboard, and an output apparatus such as a display are connected to the input/output interface 1100. A method in which the input/output interface 1100 is connected to the input apparatus and the output apparatus may be wireless connection, or may be wired connection.

The network interface 1120 is an interface for connecting the computer 1000 to a network. The communication network is, for example, a local area network (LAN) or a wide area network (WAN). A method in which the network interface 1120 is connected to a network may be wireless connection, or may be wired connection.

The computer 1000 according to the present example embodiment is connectable to the measurement apparatus 20 via the input/output interface 1100 or the network interface 1120. Moreover, the computer 1000 according to the present example embodiment is connectable to the terminal 30 via the input/output interface 1100 or the network interface 1120.

The storage device 1080 stores a program module that achieves each functional configuration unit of the information processing apparatus 10. The processor 1040 reads each of the program modules onto the memory 1060, executes the read program module, and thereby achieves a function being associated with each of the program modules.

Moreover, in a case where the subject storage unit 120, the analysis storage unit 140, and the state information storage unit 160 are each provided inside the information processing apparatus 10, for example, each of the subject storage unit 120, the analysis storage unit 140, and the state information storage unit 160 is achieved by use of the storage device 1080.

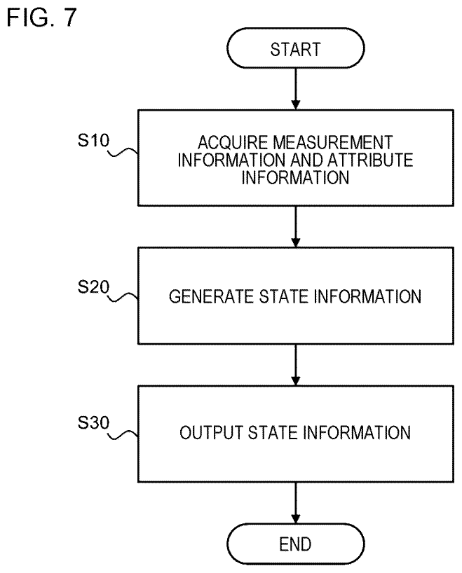

FIG. 7 is a diagram illustrating an outline of an information processing method according to the present example embodiment. The information processing method according to the present example embodiment is executed by one or more computers. The present information processing method includes an acquisition step S10, an analysis step S20, and an output step S30. In the acquisition step S10, measurement information indicating at least one of a brain wave and a vital sign of a subject during learning, and attribute information of the subject are acquired. In the analysis step S20, state information relating to a state of the subject is generated by use of the measurement information and the attribute information. In the output step S30, the state information is output.

The information processing method according to the present example embodiment is executable by the information processing apparatus 10.

In the present example embodiment, in a case where an operation of starting processing of the information processing apparatus 10 is performed, the acquisition step S10 to the output step S30 are repeatedly performed. Alternatively, output of state information from the output unit 150 to the terminal 30 may be performed due to a fact that a request operation is performed. In that case, the acquisition step S10 and the analysis step S20 may be performed only in a case where a request operation is performed, or may be further performed in other periods. The state information generated by the analysis unit 130 is preferably held in a storage apparatus accessible from the output unit 150, regardless of whether the state information is output from the output unit 150 to the terminal 30. In other words, the output unit 150 may output state information to the state information storage unit 160. This is because information can be confirmed afterwards. Moreover, measurement information acquired by the acquisition unit 110 may be further held in the analysis storage unit 140.

In a case where state information includes a plurality of types of information, some types of information (e.g., an average values relating to a plurality of subjects) may be always output from the output unit 150, and another type of information (e.g., state information of a specific subject) may be output from the output unit 150 in response to a request operation. In this way, output of information by the terminal 30 does not become miscellaneous, and it becomes easy for a user to recognize a content.

As described above, according to the present example embodiment, the analysis unit 130 generates state information relating to a state of a subject by use of measurement information and attribute information. Therefore, more accurate state estimation can be performed by taking into account an attribute of a subject.

### Second Example Embodiment

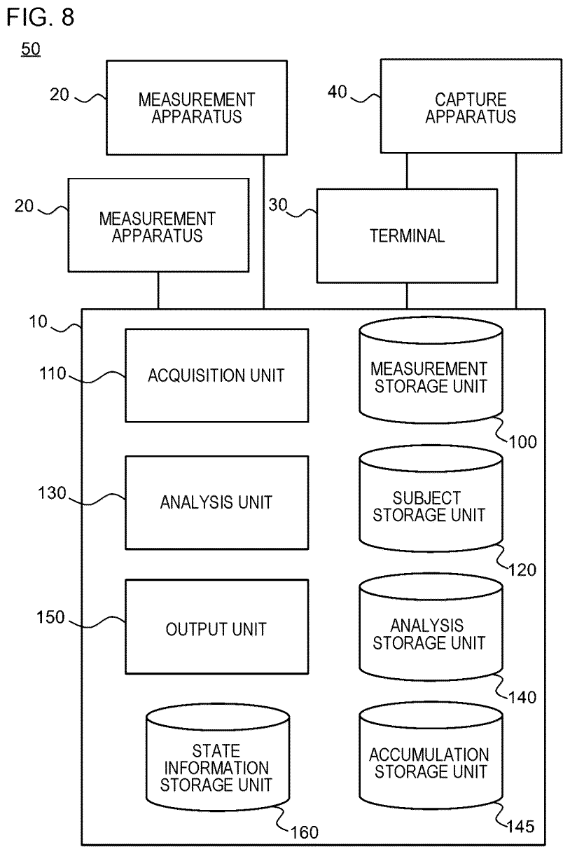

FIG. 8 is a diagram illustrating a functional configuration of a system 50 according to a second example embodiment. The system 50 according to the present example embodiment is the same as the system 50 according to the first example embodiment except for a point described below:

In the first example embodiment, an example in which state information is a state of a subject at a measurement time point where measurement information is acquired has been described, but, in the present example embodiment, an example in which state information relates to a state of a subject after a measurement time point where measurement information is acquired is described. However, an analysis unit 130 of an information processing apparatus 10 according to the present example embodiment may generate both state information relating to a state of a subject at a measurement time point where measurement information is acquired, and state information relating to a state of a subject after a measurement time point where measurement information is acquired. Hereinafter, state information relating to a state of a subject at a measurement time point where measurement information is acquired is also referred to as first state information. Hereinafter, state information relating to a state of a subject after a measurement time point where measurement information is acquired is also referred to as second state information.

The analysis unit 130 of the information processing apparatus 10 according to the present example embodiment generates state information relating to a learning state of a subject after a measurement time point, further by use of learning information indicating at least a learning content at a measurement time point of measurement information. Moreover, the analysis unit 130 generates state information by use of accumulated information or a model held in an accumulation storage unit 145. In the example of FIG. 8, the accumulation storage unit 145 is provided inside the information processing apparatus 10, but the accumulation storage unit 145 may be provided outside the information processing apparatus 10. In a case where the accumulation storage unit 145 is provided inside the information processing apparatus 10, for example, the accumulation storage unit 145 is achieved by use of a storage device 1080.

Learning information includes at least a learning content. Examples of a learning content include a curriculum, a unit, and a page number of a text or the like. A learning content is input to a terminal 30 at start of learning. For example, at start of a lesson, a user inputs a curriculum, a unit, and the like of the lesson to the terminal 30. An acquisition unit 110 of the information processing apparatus 10 can acquire learning information from the terminal 30.

A learning state includes, for example, one or more of an accomplishment degree, an understanding degree, a concentration degree, and a test result.

The analysis unit 130 generates state information relating to a learning state of a subject after a measurement time point, and, thereby, the information processing apparatus 10 according to the present example embodiment previously recognizes a state transition of the subject, and can consider an action according to a need.

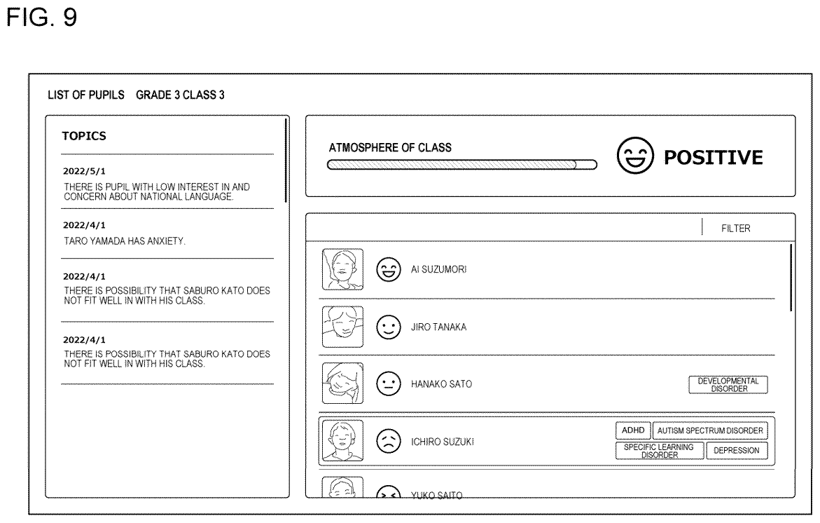

FIG. 9 is a diagram illustrating an image displayed on the terminal 30 according to the present example embodiment. With the present image, information of an entire class can be overlooked. A user of the terminal 30, such as a teacher, can confirm such a display content after a lesson or the like, recognize current status of the class, and improve subsequent instruction. In a column “TOPICS” of the present image, a message indicating states of a plurality of members (subjects) of the class is displayed. A message indicating a status of each subject is generated based on state information. By confirming such a message, an instructor can recognize a student to be taken care of. Note that, a message may be displayed only in a case where state information satisfies a predetermined condition.

Moreover, in the example of FIG. 9, “ATMOSPHERE OF CLASS” based on an average of emotions of all members of the class is displayed. The average of an emotion is, for example, an average of state information during a most recent lesson, or an average of state information during a most recent predetermined period (e.g., one week).

Further, in the example of FIG. 9, states of a plurality of members of a class are displayed in a list. As information of each member, a face photograph, a symbol indicating an emotion, a name, and an attribute of the member are displayed. A state of each member is, for example, an average of state information during a most recent lesson, or an average of state information during a most recent predetermined period (e.g., one week).

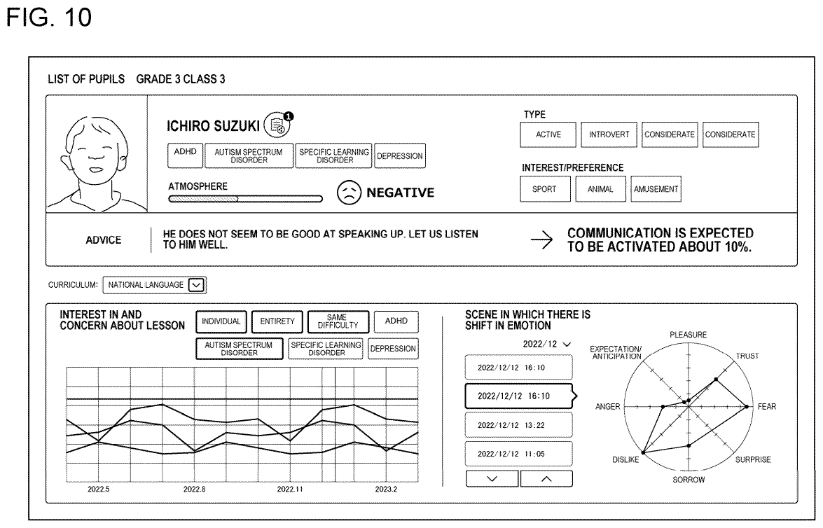

FIG. 10 is a diagram illustrating another example of an image displayed on the terminal 30 according to the present example embodiment. FIG. 10 is an image displaying information of an individual subject. For example, by selecting one of the members in the member list of FIG. 9, transition can be made to an image of FIG. 10.

In an example of FIG. 10, a face photograph, a name, a class, and an attribute of one subject are displayed. Moreover, advice based on a prediction result of a subsequent state is further displayed. In addition, in a lower left part of FIG. 10, a line graph indicating time-series data of interest in or concern about (one example of an emotion) a lesson is displayed. In the graph, not only a state of a subject being a display target in the image (“INDIVIDUAL”), but also each of an entire average (“ENTIRETY”) based on state information of a plurality of subjects, an average of a subject with each attribute (“ADHD”, “AUTISM SPECTRUM DISORDER”, “SPECIFIC LEARNING DISORDER”, and “DEPRESSION”), and an average of subjects who have the same combination of attributes as a subject being a display target (“SAME DIFFICULTY”) can be selected and displayed. Therefore, a user can confirm transition of an average state of a learner with a similar characteristic. In the example of FIG. 10,

“INDIVIDUAL”, “ENTIRETY”, “AUTISM SPECTRUM DISORDER”, and “SAME DIFFICULTY” are selected, and data thereof are displayed. Note that, the graph can include past information and future information.

Moreover, the graph is displayable by switching a curriculum. In this way, the terminal 30 can output state information in a comparable state between a plurality of curricula or between a plurality of units. Further, a type of state to be displayed may be allowed to be changed from, for example, “INTEREST IN AND CONCERN ABOUT LESSON” to “UNDERSTANDING DEGREE” or the like.

Moreover, in a lower right part of FIG. 10, information for confirming a scene in which there is a shift in emotion is displayed. Specifically, a date and time at a time point where there is a shift in emotion is displayed in a list. A time point where there is a shift in emotion is, for example, a time point where a likelihood or a score of one of emotions indicated in state information generated by the analysis unit 130 changes by equal to or more than a predetermined change rate. Then, a state of a subject at a selected date and time among the displayed list of dates and times is displayed in a radar chart.

The information processing apparatus 10 according to the present example embodiment can output, based on a comparison result between information of a subject and accumulated data of a pupil or a student with the same or a similar characteristic, information such as a future prediction comment, information of a curriculum and a unit that are likely to cause trouble, a predicted understanding degree, and the like can be output. Therefore, an instructor can sense an indication that support becomes necessary for a subject.

As another example, the terminal 30 may further output a three-dimensional model video that reproduces status of a subject during learning including a surrounding environment. For example, by reproducing and confirming status before and after the above-described time point where there is a shift in emotion, it becomes easy to determine a cause thereof. An image for generating a three-dimensional model video is captured by, for example, a capture apparatus 40.

In the example of FIG. 8, the information processing apparatus 10 includes a measurement storage unit 100. In a case where the measurement storage unit 100 is provided inside the information processing apparatus 10, the measurement storage unit 100 is achieved by use of, for example, the storage device 1080. In the present example embodiment, the acquisition unit 110 can accumulate measurement information acquired from a measurement apparatus 20 in the measurement storage unit 100 in association with an individual ID. In the present example embodiment, the analysis unit 130 does not need to generate state information in real time. The analysis unit 130 can generate state information by processing, afterwards, the measurement information held in the measurement storage unit 100. Moreover, the analysis unit 130 may generate state information by use of time-series data of measurement information.

In the present example embodiment, an output unit 150 causes the state information storage unit 160 to hold state information generated by the analysis unit 130. For example, the output unit 150 reads state information from the state information storage unit 160 in response to a request from the terminal 30, and outputs the state information to the terminal 30. Therefore, a user of 30 can confirm state information at a desired timing afterwards.

Examples of a method in which the analysis unit 130 according to the present example embodiment generates state information relating to a learning state of a subject after a measurement time point of the measurement information are described below as a third example and a fourth example.

### Third Example

In the third example, the accumulation storage unit 145 holds, for example, accumulated information of a plurality of past learners. Each piece of accumulated information is time-series data of at least one of measurement information and first state information. The first state information is, for example, information previously generated, based on measurement information, by the method described in the first example embodiment. Moreover, each piece of accumulated information is associated with one attribute or a combination of two or more attributes. Further, in each piece of accumulated information, a learning log is associated with data at each time point of time-series data. Each learning log includes at least a learning content. Moreover, each learning log includes a learning state.

The analysis unit 130 predicts a subsequent state of a subject by comparing at least one of measurement information and first state information of the subject with the accumulated information held in the accumulation storage unit 145.

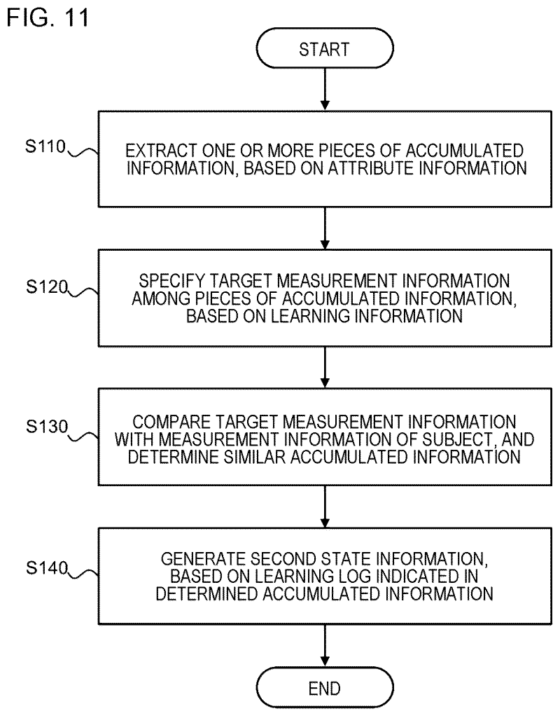

FIG. 11 is a flowchart illustrating a flow of processing executed by the analysis unit 130 according to the present example. In step S110, the analysis unit 130 extracts one or more pieces of accumulated information associated with one or more attributes corresponds to attribute information of a subject, from among a plurality of pieces of accumulated information held in the accumulation storage unit 145. In other words, the analysis unit 130 extracts one or more pieces of accumulated information in such a way that one or more attributes indicated in the attribute information of the subject match one or more attributes associated with accumulated information to be extracted.

In step S120, the analysis unit 130 specifies measurement information associated with the same learning content as the learning content indicated in the learning information acquired by the acquisition unit 110 from among pieces of the time-series measurement information in each piece of extracted accumulated information. In this way, pieces of information on the same learning content can be compared.

In step S130, the analysis unit 130 compares the measurement information specified in each of one or more pieces of extracted accumulated information with the measurement information of the subject acquired by the acquisition unit 110. As a result, the analysis unit 130 determines, as similar accumulated information, accumulated information in which the specified measurement information is most similar to the measurement information of the subject, among the one or more accumulated information. Note that, a comparison between the measurement information of the accumulated information and the measurement information of the subject may be performed with any one index included in the measurement information, or may be performed with a plurality of indices (e.g. a brain wave and a pulse rate). In the latter case, the analysis unit 130 can compute a difference between the measurement information of the subject and the measurement information of the accumulated information regarding each index, and determine, as similar accumulated information, accumulated information with the smallest sum or average of a plurality of acquired differences.

Moreover, a comparison between the measurement information of the accumulated information and the measurement information of the subject may be a comparison of time-series data. In this case, a similarity degree of time-series data is computed by use of an existing method, and accumulated information with the highest similarity degree is determined as similar accumulated information.

It is estimated that a learning state of a content that the subject learns later on is similar to a learning state indicated in a learning log of the determined similar accumulated information. Accordingly; in step S140, the analysis unit 130 generates second state information of the subject, based on a learning log indicated in the determined accumulated information. In other words, the analysis unit 130 designates, as second state information, a learning state indicated in the learning log included in the determined similar accumulated information. Information indicating a learning content is associated with the second state information. Moreover, the analysis unit 130 associates the second state information with an individual ID of the subject.

According to the second state information, for example, a learning content in which a subject is weak in a future can be predicted.

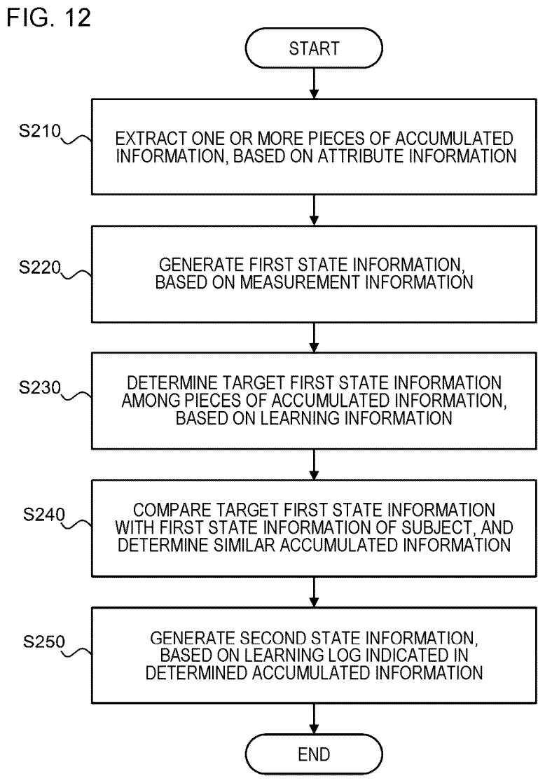

FIG. 12 is a flowchart illustrating another example of a flow of processing executed by the analysis unit 130. In the present example, similar accumulated information is determined by comparing first state information of accumulated information and first state information of a subject.

Step S210 is the same as step S110 in FIG. 11. Subsequently, in step S220, the analysis unit 130 generates first state information, based on measurement information of the subject acquired by the acquisition unit 110. Generation of the first state information can be performed by a method similar to that described in the first example embodiment.

In step S230, the analysis unit 130 specifies first state information associated with the same learning content as a learning content indicated in learning information acquired by the acquisition unit 110, from among pieces of time-series first state information of each piece of accumulated information extracted in step S210.

In step S240, the analysis unit 130 compares the first state information specified in each of the extracted one or more pieces of accumulated information with the first state information of the subject generated in step S220. As a result, the analysis unit 130 determines, as similar accumulated information, accumulated information in which the specified first state information is most similar to the first state information of the subject, among the one or more pieces of accumulated information. Note that, a comparison between the first state information of the accumulated information and the first state information of the subject may be performed with any one of the indices included in the first state information, or may be performed with a plurality of indices (e.g., a calmness degree and an understanding degree). A specific example of the latter case is similar to that described above regarding measurement information. Moreover, a comparison between the first state information of the accumulated information and the first state information of the subject may also be a comparison of time series data of both. In this case, a similarity degree of time-series data is computed by use of an existing method, and accumulated information with the highest similarity degree is designated as similar accumulated information.

Step S250 is the same as step S140 in FIG. 11.

Note that, the analysis unit 130 may determine similar accumulated information by a combination of measurement information and first state information.

In the third example, the measurement information acquired by the acquisition unit 110 and the state information generated by the analysis unit 130 may be held in the accumulation storage unit 145 as at least a part of the accumulated information.

### Fourth Example

In a fourth example, the accumulation storage unit 145 holds a plurality of models generated by machine learning. Each of the plurality of models is associated with one attribute or a combination of two or more attributes. The analysis unit 130 selects a model to be used from a plurality of models, based the attribute information of the subject, reads the selected model, and uses the model for generation of state information, in a way similar to that described in the first example embodiment.

Input of a model according to the present example is measurement information of the subject, and learning information. However, measurement information input to the model may be time-series data of the measurement information. Then, output of a model according to the present example is information indicating a learning state in each learning content. Such a model can be generated, for example, by machine learning using, as training data, a plurality of pieces of accumulated information described in the third example.

The analysis unit 130 inputs, to a model read from the accumulation storage unit 145, the measurement information and the learning information acquired by the acquisition unit 110. Then, as an output of a model, information indicating a learning state in each learning content is acquired. Then, the analysis unit 130 designates, as second state information, the acquired information indicating the learning state. The analysis unit 130 associates the learning content and an individual ID of the subject with the second state information.

According to the third and fourth examples described above, second state information for a plurality of learning contents is generated. In other words, the analysis unit 130 generates state information for each curriculum or unit. Accordingly, the analysis unit 130 may further extract second state information associated with a learning content that the subject has not learned, from the plurality of pieces of generated second state information. For example, information indicating a learning content that the subject has learned is held in a storage apparatus accessible by the analysis unit 130, and the analysis unit 130 can read and use the information.

Moreover, the analysis unit 130 may include, in state information, advice information relating to instruction to a subject. The analysis unit 130 can select advice information according to a predicted learning state from among a plurality of pieces of previously prepared advice information, and include the advice information in the state information.

Note that, the method by which the analysis unit 130 generates state information is not limited to the example described above, and various methods are adoptable.

Next, an advantage and an effect of the present example embodiment are described. In the present example embodiment, an advantage and an effect similar to those according to the first example embodiment can be acquired. In addition, the analysis unit 130 of the information processing apparatus 10 according to the present example embodiment generates state information relating to a learning state of a subject after a measurement time point, further by use of learning information indicating at least a learning content at the measurement time point of the measurement information. Therefore, state transition of a subject can be previously recognized, and a preventive measure can be considered according to a need.

### Modified Example

A system 50 according to the present example embodiment is the same as the system 50 according to the first or second example embodiment except for points described below:

In the present modified example, the system 50 includes, as a measurement apparatus 20, a capture apparatus such as a thermography camera that captures a subject from a position away from the subject and measures a vital sign. In a case where the measurement apparatus 20 is a capture apparatus, the measurement apparatus 20 outputs an image. In a case where the measurement apparatus 20 is a thermography camera, an image indicating a temperature at each position within a capture range is output from the measurement apparatus 20. A capture region of the measurement apparatus 20 may be fixed or variable.

In a case where the measurement apparatus 20 is a capture apparatus, an acquisition unit 110 of an information processing apparatus 10 acquires measurement information by processing an image of a subject during learning. In other words, the measurement apparatus 20 captures a subject during learning, and generates an image. Then, the measurement apparatus 20 outputs the generated image. The acquisition unit 110 acquires the image output from the measurement apparatus 20.

Herein, in a case where the measurement apparatus 20 is provided in such a way as to mainly capture a specific subject, the measurement apparatus 20 is associated with a subject whom the measurement apparatus 20 designates as a measurement target. Then, similarly to the example of the contact-type measurement apparatus 20 described above, an individual ID is associated with measurement information.

On the other hand, in a case where the measurement apparatus 20 captures a plurality of subjects, for example, the acquisition unit 110 can associate measurement information and an individual ID of each subject by performing the following processing.

In subject information held in a subject storage unit 120 according to the present modified example, position information indicating a position within an image is previously associated with each of a plurality of individual IDs. The position information can be prepared, for example, based on a seat position or the like determined for each subject in a classroom. The acquisition unit 110 specifies a position being associated with each individual ID by use of the position information. Then, the acquisition unit 110 extracts information at a position being associated with each individual ID, from the image acquired from the measurement apparatus 20. For example, in a case where an image acquired by the measurement apparatus 20 is a thermography image, the acquisition unit 110 specifies, by use of position information, a coordinate in the image being associated with a certain individual ID. Then, the acquisition unit 110 associates a temperature at the coordinate in the thermography image with the individual ID. Note that, each individual ID may be associated with information indicating a region in the image. In this case, the acquisition unit 110 may compute an average of temperature within the region in the thermography image, and associate the average with the individual ID.

Otherwise, a position of each subject may be detected by use of an image acquired by a capture apparatus 40. In this case, in subject information in the subject storage unit 120, each individual ID is further associated with a feature value for face recognition processing. In a case where the acquisition unit 110 of the information processing apparatus 10 acquires the feature value of the subject from the subject storage unit 120, the acquisition unit 110 performs, by use of the feature value, face recognition processing on the image generated by the capture apparatus 40. In this way, a position of the subject in the image is specified. Moreover, a position of the subject in a real space can be specified by use of a position of the subject in the image, a position of the capture apparatus 40, and a relationship between the capture apparatus 40 and a capture region of the capture apparatus 40. Further, by use of a position of the measurement apparatus 20 and a relationship between the measurement apparatus 20 and a capture region of the measurement apparatus 20, the acquisition unit 110 can specify a position of the subject in the captured image of the measurement apparatus 20.

In the present example embodiment as well, an advantage and an effect similar to those according to the first or second example embodiment can be acquired.

The example embodiments according to the present invention have been described above with reference to the drawings, but are exemplifications of the present invention, and various configurations other than those described above can also be adopted.

Moreover, although a plurality of processes (pieces of processing) are described in order in a plurality of flowcharts used in the above description, an execution order of processes executed in each example embodiment is not limited to the described order. In each example embodiment, an order of illustrated processes can be changed to an extent that causes no problem in terms of content. Moreover, the example embodiments described above can be combined to an extent that content does not contradict.

Some or all of the above-described example embodiments can also be described as, but are not limited to, the following supplementary notes.

1-1. An information processing apparatus including:
an acquisition unit that acquires measurement information indicating at least one of a brain wave and a vital sign of a subject during learning, and attribute information of the subject;
an analysis unit that generates state information relating to a state of the subject by use of the measurement information and the attribute information; and
an output unit that outputs the state information.

1-2. The information processing apparatus according to supplementary note 1-1, wherein
the state information relates to at least one of a state of the subject at a measurement time point where the measurement information is acquired, and a state of the subject after the measurement time point.

1-3. The information processing apparatus according to supplementary note 1-1 or 1-2, wherein
the state information indicates at least one of an emotion, a concentration degree, and an understanding degree of the subject.

1-4. The information processing apparatus according to any one of supplementary notes 1-1 to 1-3, wherein
the output unit outputs the state information in real time to a terminal used by an instructor who instructs the subject at the measurement time point.

1-5. The information processing apparatus according to any one of supplementary notes 1-1 to 1-4, wherein
the output unit further outputs notification information to the terminal in a case where the state information satisfies a previously determined condition.

1-6. The information processing apparatus according to supplementary note 1-2, wherein
the analysis unit generates the state information relating to a learning state of the subject after the measurement time point by further use of learning information indicating at least a learning content at the measurement time point.

1-7. The information processing apparatus according to supplementary note 1-6, wherein
the state information includes advice information relating to instruction to the subject.

1-8. The information processing apparatus according to supplementary note 1-6 or 1-7, wherein
the analysis unit generates the state information for each curriculum or unit.

1-9. The information processing apparatus according to supplementary note 1-8, wherein
the output unit outputs the state information to a terminal, and
the terminal outputs the state information in a comparable state between a plurality of curricula or between a plurality of units.

1-10. The information processing apparatus according to any one of supplementary notes 1-1 to 1-9, wherein
the attribute information includes an attribute relating to a factor needing support.

1-11. The information processing apparatus according to supplementary note 1-10, wherein
the attribute information includes at least one of information relating to difficulty of the subject and information relating to a language of the subject.

1-12. The information processing apparatus according to any one of supplementary notes 1-1 to 1-11, wherein
the analysis unit generates the state information by use of a model generated by machine learning.

1-13. The information processing apparatus according to supplementary note 1-12, wherein
the attribute information indicates one or more attributes,
a plurality of the models each associated with one attribute or a combination of two or more attributes are held in an analysis storage unit, and
the analysis unit selects, based on the attribute information of the subject, the model to be used from among the plurality of models, and uses the selected model for generation of the state information.

1-14. The information processing apparatus according to any one of supplementary notes 1-1 to 1-13, wherein
the acquisition unit acquires the measurement information by processing an image of the subject during learning.

1-15. The information processing apparatus according to any one of supplementary notes 1-1 to 1-14, wherein
the analysis unit generates the state information by further use of an image of the subject during learning.

2-1. A system including:
the information processing apparatus according to any one of supplementary notes 1-1 to 1-15;
a measurement apparatus that measures at least one of a brain wave and a vital sign of the subject; and
a terminal to which the output unit outputs the state information.

3-1. An information processing method including,
by one or more computers;
acquiring measurement information indicating at least one of a brain wave and a vital sign of a subject during learning, and attribute information of the subject;
generating state information relating to a state of the subject by use of the measurement information and the attribute information; and
outputting the state information.

3-2. The information processing method according to supplementary note 3-1, wherein
the state information relates to at least one of a state of the subject at a measurement time point where the measurement information is acquired, and a state of the subject after the measurement time point.

3-3. The information processing method according to supplementary note 3-1 or 3-2, wherein
the state information indicates at least one of an emotion, a concentration degree, and an understanding degree of the subject.

3-4. The information processing method according to any one of supplementary notes 3-1 to 3-3, wherein
the output unit outputs the state information in real time to a terminal used by an instructor who instructs the subject at the measurement time point.

3-5. The information processing method according to any one of supplementary notes 3-1 to 3-4, further including,
by the one or more computers,
outputting notification information to the terminal in a case where the state information satisfies a previously determined condition.

3-6. The information processing method according to supplementary note 3-2, wherein
the one or more computers generates the state information relating to a learning state of the subject after the measurement time point by further use of learning information indicating at least a learning content at the measurement time point.

3-7. The information processing method according to supplementary note 3-6, wherein
the state information includes advice information relating to instruction to the subject.

3-8. The information processing method according to supplementary note 3-6 or 3-7, wherein
the one or more computers generates the state information for each curriculum or unit.

3-9. The information processing method according to supplementary note 3-8, wherein
the one or more computers outputs the state information to a terminal, and
the terminal outputs the state information in a comparable state between a plurality of curricula or between a plurality of units.

3-10. The information processing method according to any one of supplementary notes 3-1 to 3-9, wherein
the attribute information includes an attribute relating to a factor needing support.

3-11. The information processing method according to supplementary note 3-10, wherein
the attribute information includes at least one of information relating to difficulty of the subject and information relating to a language of the subject.

3-12. The information processing method according to any one of supplementary notes 3-1 to 3-11, wherein
the one or more computers generates the state information by use of a model generated by machine learning.

3-13. The information processing method according to supplementary note 3-12, wherein
the attribute information indicates one or more attributes, and
a plurality of the models each associated with one attribute or a combination of two or more attributes are held in an analysis storage unit,
the information processing method further including,
by the one or more computers,
selecting, based on the attribute information of the subject, the model to be used from among the plurality of models,
wherein the one or more computers uses the selected model for generation of the state information.

3-14. The information processing method according to any one of supplementary notes 3-1 to 3-13, wherein
the one or more computers acquires the measurement information by processing an image of the subject during learning.

3-15. The information processing method according to any one of supplementary notes 3-1 to 3-14, wherein
the one or more computers generates the state information by further use of an image of the subject during learning.

4-1. A program causing a computer to function as:
an acquisition unit that acquires measurement information indicating at least one of a brain wave and a vital sign of a subject during learning, and attribute information of the subject;
an analysis unit that generates state information relating to a state of the subject by use of the measurement information and the attribute information; and
an output unit that outputs the state information.

4-2. The program according to supplementary note 4-1, wherein
the state information relates to at least one of a state of the subject at a measurement time point where the measurement information is acquired, and a state of the subject after the measurement time point.

4-3. The program according to supplementary note 4-1 or 4-2, wherein
the state information indicates at least one of an emotion, a concentration degree, and an understanding degree of the subject.

4-4. The program according to any one of supplementary notes 4-1 to 4-3, wherein
the output unit outputs the state information in real time to a terminal used by an instructor who instructs the subject at the measurement time point.

4-5. The program according to any one of supplementary notes 4-1 to 4-4, wherein
the output unit further outputs notification information to the terminal in a case where the state information satisfies a previously determined condition.

4-6. The program according to supplementary note 4-2, wherein
the analysis unit generates the state information relating to a learning state of the subject after the measurement time point by further use of learning information indicating at least a learning content at the measurement time point.

4-7. The program according to supplementary note 4-6, wherein
the state information includes advice information relating to instruction to the subject.

4-8. The program according to supplementary note 4-6 or 4-7, wherein
the analysis unit generates the state information for each curriculum or unit.

4-9. The program according to supplementary note 4-8, wherein
the output unit outputs the state information to a terminal, and
the terminal outputs the state information in a comparable state between a plurality of curricula or between a plurality of units.

4-10. The program according to any one of supplementary notes 4-1 to 4-9, wherein
the attribute information includes an attribute relating to a factor needing support.

4-11. The program according to supplementary note 4-10, wherein
the attribute information includes at least one of information relating to difficulty of the subject and information relating to a language of the subject.

4-12. The program according to any one of supplementary notes 4-1 to 4-11, wherein
the analysis unit generates the state information by use of a model generated by machine learning.

4-13. The program according to supplementary note 4-12, wherein
the attribute information indicates one or more attributes,
a plurality of the models each associated with one attribute or a combination of two or more attributes are held in an analysis storage unit, and
the analysis unit selects, based on the attribute information of the subject, the model to be used from among the plurality of models, and uses the selected model for generation of the state information.

4-14. The program according to any one of supplementary notes 4-1 to 4-13, wherein
the acquisition unit acquires the measurement information by processing an image of the subject during learning.

4-15. The program according to any one of supplementary notes 4-1 to 4-14, wherein
the analysis unit generates the state information by further use of an image of the subject during learning.

5-1. A computer-readable medium recording a program,
the program causing a computer to function as:
   an acquisition unit that acquires measurement information indicating at least one of a brain wave and a vital sign of a subject during learning, and attribute information of the subject;
   an analysis unit that generates state information relating to a state of the subject by use of the measurement information and the attribute information; and
   an output unit that outputs the state information.

5-2. The medium according to supplementary note 5-1, wherein
the state information relates to at least one of a state of the subject at a measurement time point where the measurement information is acquired, and a state of the subject after the measurement time point.

5-3. The medium according to supplementary note 5-1 or 5-2, wherein
the state information indicates at least one of an emotion, a concentration degree, and an understanding degree of the subject.

5-4. The medium according to any one of supplementary notes 5-1 to 5-3, wherein
the output unit outputs the state information in real time to a terminal used by an instructor who instructs the subject at the measurement time point.

5-5. The medium according to any one of supplementary notes 5-1 to 5-4, wherein
the output unit further outputs notification information to the terminal in a case where the state information satisfies a previously determined condition.

5-6. The medium according to supplementary note 5-2, wherein
the analysis unit generates the state information relating to a learning state of the subject after the measurement time point by further use of learning information indicating at least a learning content at the measurement time point.

5-7. The medium according to supplementary note 5-6, wherein
the state information includes advice information relating to instruction to the subject.

5-8 The medium according to supplementary note 5-6 or 5-7, wherein
the analysis unit generates the state information for each curriculum or unit.

5-9. The medium according to supplementary note 5-8, wherein
the output unit outputs the state information to a terminal, and the terminal outputs the state information in a comparable state between a plurality of curricula or between a plurality of units.

5-10. The medium according to any one of supplementary notes 5-1 to 5-9, wherein
the attribute information includes an attribute relating to a factor needing support.

5-11. The medium according to supplementary note 5-10, wherein
the attribute information includes at least one of information relating to difficulty of the subject and information relating to a language of the subject.

5-12. The medium according to any one of supplementary notes 5-1 to 5-11, wherein
the analysis unit generates the state information by use of a model generated by machine learning.

5-13. The medium according to supplementary note 5-12, wherein
the attribute information indicates one or more attributes,
a plurality of the models each associated with one attribute or a combination of two or more attributes are held in an analysis storage unit, and
the analysis unit selects, based on the attribute information of the subject, the model to be used from among the plurality of models, and uses the selected model for generation of the state information.

5-14. The medium according to any one of supplementary notes 5-1 to 5-13, wherein
the acquisition unit acquires the measurement information by processing an image of the subject during learning.

5-15. The medium according to any one of supplementary notes 5-1 to 5-14, wherein
the analysis unit generates the state information by further use of an image of the subject during learning.

This application is based upon and claims the benefit of priority from Japanese patent application No. 2022-150214, filed on Sep. 21, 2022, the disclosure of which is incorporated herein in its entirety by reference.

### REFERENCE SIGNS LIST

10 Information processing apparatus
20 Measurement apparatus
30 Terminal
40 Capture apparatus
50 System
100 Measurement storage unit
110 Acquisition unit
120 Subject storage unit
130 Analysis unit
140 Analysis storage unit
145 Accumulation storage unit
150 Output unit
160 State information storage unit
1000 Computer
1020 Bus
1040 Processor
1060 Memory
1080 Storage device
1100 Input/output interface
1120 Network interface

What is claimed is:

1. An information processing apparatus comprising:
at least one memory storing instructions; and
at least one processor configured to execute the instructions to perform operations comprising:
acquiring measurement information indicating at least one of a brain wave and a vital sign of a subject during learning, and attribute information of the subject;
generating state information relating to a state of the subject by use of the measurement information and the attribute information; and
outputting the state information.

2. The information processing apparatus according to claim 1, wherein
the state information relates to at least one of a state of the subject at a measurement time point where the measurement information is acquired, and a state of the subject after the measurement time point.

3. The information processing apparatus according to claim 1, wherein
the state information indicates at least one of an emotion, a concentration degree, and an understanding degree of the subject.

4. The information processing apparatus according to claim 1, wherein
outputting the state information comprises outputting the state information in real time to a terminal used by an instructor who instructs the subject at a measurement time point where the measurement information is acquired.

5. The information processing apparatus according to claim 4, wherein
the operations further comprise outputting notification information to the terminal in a case where the state information satisfies a previously determined condition.

6. The information processing apparatus according to claim 2, wherein
generating the state information comprises generating the state information relating to a learning state of the subject after the measurement time point by further use of learning information indicating at least a learning content at the measurement time point.

7. The information processing apparatus according to claim 6, wherein
the state information includes advice information relating to instruction to the subject.

8. The information processing apparatus according to claim 6, wherein
generating the state information comprises generating the state information for each curriculum or unit.

9. The information processing apparatus according to claim 8, wherein
outputting the state information comprises outputting the state information to a terminal, and
the terminal outputs the state information in a comparable state between a plurality of curricula or between a plurality of units.

10. The information processing apparatus according to claim 1, wherein
the attribute information includes an attribute relating to a factor needing support.

11. The information processing apparatus according to claim 10, wherein
the attribute information includes at least one of information relating to difficulty of the subject and information relating to a language of the subject.

12. The information processing apparatus according to claim 1, wherein
generating the state information comprises generating the state information by use of a model generated by machine learning.

13. The information processing apparatus according to claim 12, wherein
the attribute information indicates one or more attributes,
a plurality of the models each associated with one attribute or a combination of two or more attributes are held in an analysis storage, and
the operations further comprise selecting, based on the attribute information of the subject, the model to be used from among the plurality of models, and
generating the state information comprises using the selected model for generation of the state information.

14. The information processing apparatus according to claim 1, wherein
acquiring the measurement information comprises acquiring the measurement information by processing an image of the subject during learning.

15. The information processing apparatus according to claim 1, wherein
generating the state information comprises generating the state information by further use of an image of the subject during learning.

16. A system comprising:
the information processing apparatus according to claim 1;
a measurement apparatus that measures at least one of a brain wave and a vital sign of the subject; and
a terminal to which the information processing apparatus outputs the state information.

17. An information processing method comprising,
by one or more computers:
acquiring measurement information indicating at least one of a brain wave and a vital sign of a subject during learning, and attribute information of the subject;
generating state information relating to a state of the subject by use of the measurement information and the attribute information; and
outputting the state information.

18. A non-transitory computer-readable medium storing a program causing a computer to execute a control method, the control method comprising:
acquiring measurement information indicating at least one of a brain wave and a vital sign of a subject during learning, and attribute information of the subject;
generating state information relating to a state of the subject by use of the measurement information and the attribute information; and
outputting the state information.
